(19) United States
(12) Patent Application Publication
(10) Pub. No.: US 2012/0197662 A1
(43) Pub. Date: Aug. 2, 2012

(54) System and Method for Facilitating Home Care Activities

(76) Inventors: Shelly A. Sun, Lake Forest, IL (US); Erin Ramczyk, Burlington, WI (US); Jayson Pearl, Pewaukee, WI (US)

(21) Appl. No.: 13/362,943

(22) Filed: Jan. 31, 2012

Related U.S. Application Data
(60) Provisional application No. 61/438,068, filed on Jan. 31, 2011.

(51) Int. Cl. G06Q 50/22

(52) U.S. Cl. 705/2

(57) ABSTRACT

A computer-implemented system for managing the tracking and completion of one or more caretaking events, including a care management interface configured to receive and track one or more caretaking events and facilitate assignment of at least one caregiver record with each of the caretaking events, wherein a caretaking event is an item to be performed by the caregiver identified in the caregiver record taken for the benefit of a home health care recipient. The system further includes a professional home care management interface configured to receive an assignment of caretaking event in a calendar item or task item, generate and transmit a home care management request including the caretaking event to a home care management system, receive a confirmation from the home care management system that the task has been assigned to the home care management system, and display an indication of the assignment in the care management interface.

### CROSS REFERENCE TO RELATED APPLICATIONS

This application claims the benefit of U.S. Provisional Application No. 61/438,068, filed Jan. 31, 2011, hereby incorporated by reference in its entirety.

### FIELD OF THE INVENTION

The present invention relates to systems and methods for implementing and managing group communication and task management. Specifically, the present invention relates to a system and method for facilitating home care activities including communication between caregivers, community members and the care recipient.

### BACKGROUND

The provision of healthcare in a care recipient's home is increasing in popularity at least in part because of the cost of long term care facilities, the desire of ill, elderly or infirm persons to remain at home and/or the desire of one or more family members to stay close to the care recipient. Home care is healthcare or supportive care provided in the care recipient's home by healthcare professionals and by family and/or friends. In most cases, home care providers include some combination of professional healthcare services and life assistance services.

The responsibility of caring for a family member or other care recipient can be a substantial burden on a primary caregiver. Providing care in the home can include being responsible for a daunting list of tasks. The tasks include companion care related tasks such as connecting home care recipients with loved ones through e-mails and social media, coordinating visits, creating customized grocery lists, playing card games, and respite care. The tasks also include personal care related tasks such as personal hygiene care and toileting, personal safety home valuations, and medication reminders. The tasks may even include home support related tasks such as organizing a closet, light housekeeping, meal cooking, and meal planning, outside support related tasks such as transportation services, managing bills, and assistance with shopping and errands. Further possible tasks include skilled care related tasks such as skilled nursing, blood sugar testing, home infusion therapy, hospice assistance, wound care, and physical therapy. All or some of these tasks need to be performed consistently and at all hours of the day and night.

Generally, primary caregivers are family members that are not trained healthcare providers and are unfamiliar with the needs and requirements of providing home health care. Often, these primary caregivers rely on assistance, either professional or nonprofessional, to perform and manage the home care responsibilities. Even when the primary caregiver is able to delegate tasks to secondary caregivers and/or a professional caregiver, the primary caregiver still has a substantial burden in coordinating the performance of the home care tasks. For example, in order to arrange transportation services, a caregiver would need to perform at least the steps of contacting a service, providing the service with information about the home healthcare recipient and their condition, providing billing and/or insurance information, and recording information received from the service in a calendar.

The primary caregiver also is presented with a substantial burden in communicating with others regarding the care recipient. The communication can be related to accomplishing activities, providing information to concerned individuals, communicating well wishes to the care recipient, etc.

Presently, non-professional primary caregivers rely on email and paper or electronic calendars to communicate with others and track information such as medications, dosages, doctors' visits, in-home professional caregivers, bills, transportation and meals. There is no single integrated tool that allows a caregiver to manage tasks, communications, appointments, journaling and professional provider access. Further, traditional calendar and communication programs lack the functionality to coordinate performance of tasks among multiple caregivers. Further, such programs do not provide functionality to obtain assistance from professional home care service when needed.

Thus, what is desirable is an integrated tool for facilitating performance and management of home care activities between, for example, a primary caregiver, one or more secondary caregivers, a professional caregiver, collectively referred to as a care giving community, and family, friends, etc. that are concerned about the care recipient but are not primarily involved in care giving, collectively referred to as a care recipient community. What is further desirable is such a system and method to facilitate assignment and delegation of tasks based on one or more criteria associated with the tasks to the care giving community. What is yet further desirable is such a system to facilitate information sharing.

### SUMMARY

The present invention provides an integrated “single stop” tool for helping a caregiver manage all of the myriad tasks and responsibilities associated with caring for a sick relative. This tool allows a primary caregiver to keep track of all the various tasks and communications associated with the provision of care. And when the primary caregiver becomes overwhelmed or simply has other responsibilities, the present invention provides a means to “hit the panic button” and offload the tasks to another caregiver. Offloading tasks is made easier by providing a central repository of information and task management for all caregivers that can be included in the offload request.

Users can offload tasks by clicking a button displayed in conjunction with a selected calendar item or task list item. When that button is clicked, the system will send a message to the caregiver and later display a confirmation that the task is being performed by the caregiver. Preferably, the confirmation also displays other information received from the caregiver such as resources assigned to the task.

According to one exemplary embodiment, the system includes a computer-implemented system for managing the tracking and completion of one or more caretaking events, including a care management interface configured to receive and track one or more caretaking events and facilitate assignment of at least one caregiver record with each of the caretaking events, wherein a caretaking event is an item to be performed by the caregiver identified in the caregiver record taken for the benefit of a home health care recipient. The system, further includes a professional home care management interface configured to receive an assignment of caretaking event in a calendar item or task item, generate and transmit a home care management request including the caretaking event to a professional home care management system, receive a confirmation from the professional home care management system that the task has been assigned to the professional home care management system, and display an indication of the assignment in the care management interface.

According to another exemplary embodiment, a computer-implemented home care management system includes a care calendar engine configured to receive and track one or more calendar items, each calendar item including a caretaking event and a caregiver designation field and a care task list engine configured to receive and track one or more task list items, each task list item including a caretaking event and a caregiver designation field. The system further includes a caregiver database, including one or more caregiver records, each caregiver record including identification of a caregiver, a caregiver categorization, and a listing of caregiver competencies and a care management interface configured to display the calendar items and care task list items and facilitate assignment of at least one caregiver record with each of the calendar items and care task list items in the caregiver designation field. The caretaking events are items to be performed by the caregiver identified in the caregiver record taken for the benefit of a home health care recipient.

According to another exemplary embodiment, the caretaking events are downloaded over a network connection from a hospital and include patient medical information generated by a healthcare provider at the hospital and the care management interface is configured to modify one or more existing caretaking events based on the received patient medical information.

According to another exemplary embodiment, at least one caretaking event is associated with an expertise requirement. In such a system, the caregiver records are configured to include a caregiver expertise field and the care management interface is configured such that caretaking, events having an expertise requirement can only be assigned to caregiver having a correlated expertise in their caregiver record. The system may be further configured such that the care management system is configured to require validation information, received from an external system, prior to populating the caregiver expertise field.

According to another exemplary embodiment, a computer-implemented home care management system includes a care calendar engine configured to receive and track one or more calendar items, each calendar item including a caretaking event and a caregiver designation field and a care task list engine configured to receive and track one or more task list items, each task list item including a caretaking event and a caregiver designation field. The system further includes a caregiver database, including one or more caregiver records, each caregiver record including identification of a caregiver, a caregiver categorization, and a listing of caregiver competencies and a care management interface configured to display the calendar items and care task list items and facilitate assignment of at least one caregiver record with each of the calendar items and care task list items in the caregiver designation field, wherein a caretaking event is an item to be performed by the caregiver identified in the caregiver record taken for the benefit of a home health care recipient. The system yet further includes a professional home care management interface configured to receive an assignment of caretaking event in a calendar item or task item, generate and transmit a home care management request including the caretaking event to a home care management system, receive a confirmation from the home care management system that the task has been assigned to the home care management system, and display an indication of the assignment in the care management interface.

According to another exemplary embodiment, a received confirmation is configured to include additional information related to the performance of the caretaking event and the care management interface is configured to display the additional information in combination with the item including the caretaking event. The additional information may also be configured to include an identification of the caregiver assigned to perform the caretaking event. The identification and include a photograph of the caregiver assigned to perform the caretaking event to be displayed in combination with the item including the caretaking event.

According to another exemplary embodiment, a computer-implemented method for providing home care management system includes receiving and tracking one or more calendar items, each calendar item including a caretaking event and a caregiver designation field, receiving and tracking one or more task list items, each task list item including a caretaking event and a caregiver designation field, and receiving an assignment of at least one caregiver record, each caregiver record including identification of a caregiver, a caregiver categorization, and a listing of caregiver competencies, with each of the calendar items and care task list items in the caregiver designation field, wherein a caretaking event is an item to be performed by the caregiver identified in the caregiver record taken for the benefit of a home health care recipient. The method further includes receiving a delegation of a caretaking event to a professional home care management interface, including receiving an assignment of caretaking event in a calendar item or task item, generating and transmitting a home care management request including the caretaking event to a home care management system, receiving a confirmation from the home care management system that the task has been assigned to the home care management system, and displaying an indication of the assignment in the care management interface.

Other features and advantages of the invention will become apparent to those skilled in the art from the following detailed description and accompanying drawings. It should be understood, however, that the detailed description and specific examples, while indicating the preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a block diagram illustrating a home care network system for facilitating the performance, management, and delegation of home care activities, according to an exemplary embodiment;

FIG. 2 is a block diagram illustrating the home care activity management system of FIG. 1 in further detail, according to an exemplary embodiment;

FIG. 3 is a block diagram illustrating a home care activity management interface, according to an exemplary embodiment;

FIG. 4 is a flowchart illustrating a method for facilitating home care, according to an exemplary embodiment; and

FIG. 5 is a flowchart illustrating a method for assignment of an item displayed on the interface of FIG. 3 to a professional home care management service, according to an exemplary embodiment.

Before explaining embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

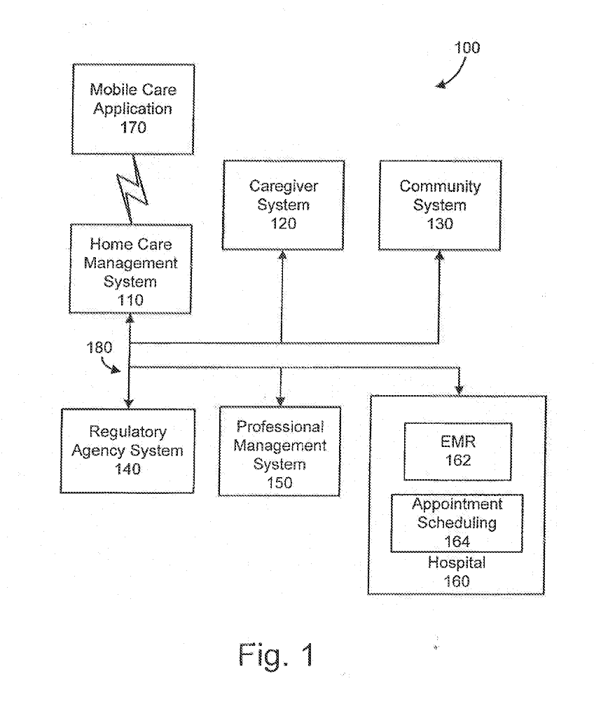

Referring now to FIG. 1, a home care network system 100 for facilitating performance, delegation and management of home care activities is shown, according to an exemplary embodiment. System 100 includes a home care management computing system 110 connected to a plurality of home care support systems through a communication network 180, such as the Internet. Home care support systems include, but are not limited to, one, or more caregiver computing systems 120, one or more community computing systems 130, a regulatory agency computing system 140, a professional home care management computing system 150, and a hospital computing system 160. Home care management computing system 110 further communicates with a mobile care application 170 to facilitate the management of home care activities. Although system 100 is shown and described as including particular systems and devices in a particular configuration, it should be understood that system 100 may alternatively include more, less, and/or a different combination of devices and systems configured to implement the functionality described herein.

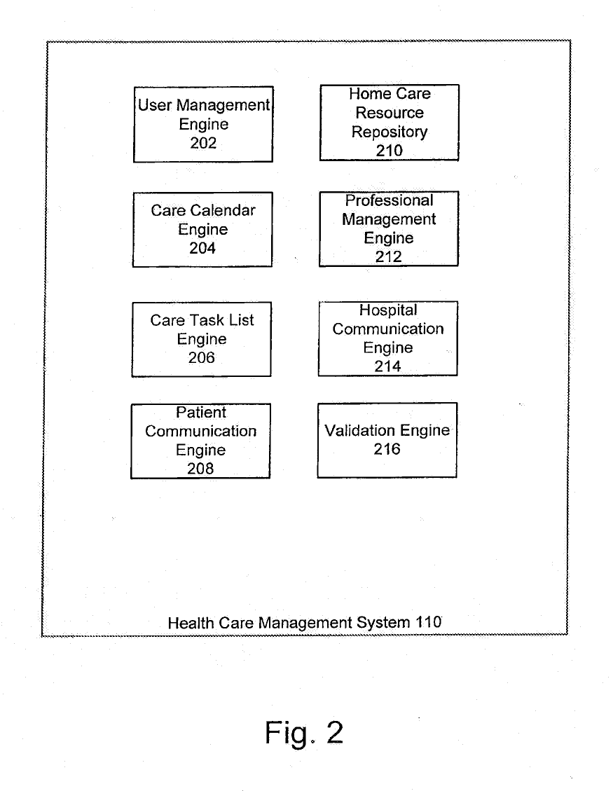

Computer system 110 is representative of the wide range of large and small computer systems that are used in computer networks of all types. For example, computer system 110 may be a desktop computing system, a laptop computing system, a handheld computing device, a smart phone, or any other web-enabled device configurable to allow a user to access implement the home care activity management functions, described below in further detail with reference to FIGS. 2-4. Although only a single computing system 110 is shown in FIG. 1, it should be understood that the method and system described herein may implemented using one or more different systems 110 and devices.

Home care management system 110 is utilized to manage and facilitate the plurality of activities associated with providing home care to a care recipient. Exemplary activities include, but are not limited to, designating individual users as caregivers and/or community members. Designating a user as a type of member includes providing identification information specific to the user type to each user. This information is stored in a database on system 110. Exemplary activities can further include generating and implementing a home care management interface, providing a home care calendar, providing a home care task list interface, providing a home care communication interface, providing a home care resource interface, etc., as will be described in further detail herein with reference to FIGS. 2-4.

Generally, use of a home care management system is performed by a user designated as a primary caregiver user. The primary caregiver user creates user accounts for other types of users, etc. and may delegate any task to any other user to perform the function described herein.

Communication network 180 is intended to be representative of the complete spectrum of computer network types including Internet and internet-like networks. Communication network 180 is utilized to allow communication between system 110 and any number of computer systems, of which computer systems 120-170 are representative.

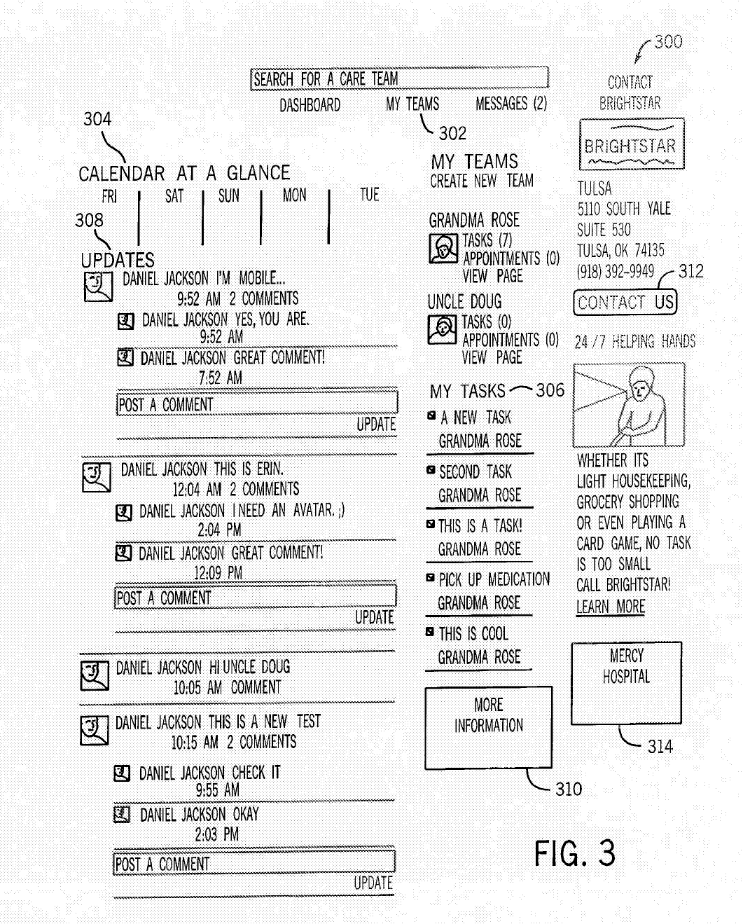

Caregiver computer system 120 is any type of computing device, similar to computing system 110, accessed by an individual user designated as a caregiver by a primary caregiver user of the home care management system 110. A caregiver computer system 120 is used to access the home care management interface described below with reference to FIGS. 2 and 3. Based on caregiver identification information, the home care management interface is configured specifically to provide information and/or functionality through computer system 120, based on permissions granted by the primary caregiver user and stored on system 110.

Community computer system 130 is a type of computing device, similar to computing systems 110 and 120, accessed by an individual user designated as a community user by a primary caregiver user of the home care management system 110. A community computer system 130 is utilized to access the home care management interface described below with reference to FIGS. 2 and 3. Based on community identification information, the home care management interface provides information and/or functionality through computer system 130. The information and/or functionality that is accessible is controlled based on permissions granted by the primary caregiver and stored on system 110 in association with the community identification information. According to an exemplary embodiment, the functionality accessible using a community computer system 130 is less than the functionality accessible using a caregiver computer system 120.

Regulatory agency computing system 140 is a type of computing device providing one or more functions associated with coordinating home care activities with regulatory requirements. In home care situation, it is often desirable for an outside regulatory agency to oversee the care of the individual to optimize the care received by the individual. Mandatory oversight is facilitated by sharing information stored within system 110, such as, but not limited to, task lists indicating completion of tasks, appointments schedules and results.

Professional home care management system 150 is a type of computing system allowing a primary caregiver and/or other caregiver to delegate one or more home care tasks to an outside contract home care management service. The home care management service provides home care services typically provided by the primary caregiver and or other caregivers and may further provide professional health care services, such as medical staffing services typically provided by a health care professional, such as a registered nurse. Professional home care management system services are described below in further detail with reference to FIGS. 2 and 3.

Hospital computing system 160 is a computing system and/or a plurality of computing systems associated with a healthcare institution. Preferably, hospital computing system 160 includes an institution at which the care recipient has been receiving and is continuing to receive medical care. System 160 preferably allows access to a care recipient's medical record, such, as an electronic medical record 162. System 160 preferably also allows a care recipient to electronically obtain health care services using the information stored and functionally implemented by system 110, such as by using an appointment scheduling interface 164.

Mobile care application 170 includes a mobile computing device configured to replicate some or all of the functionality associated herein with system 110. Application 170 further provides additional functions such as a tele-help function, a vital signs function, a photo capture and upload function.

According to an alternative embodiment, system 110 also connects to one or more additional systems configured to send and receive information with system 110. Exemplary systems may include a 3^{rd} party insurance system, a worker's compensation system, a state licensing system, and a system providing home care credentials. Exemplary information may include a record of provided care, requests for caregiver credentials, descriptions of provided care for billing purposes, medical record information, etc.

In operation, system 100 may be utilized to allow a primary caregiver to use home care management system 110 to establish a healthcare management interface allowing users to perform a plurality of functions facilitating home care activities. System 100 may further allow the primary caregiver to control both access and the degree of access for users. Access control may include controlling access to both information and functionality associated with the care recipient and accessible using system 110. Preferably, system 110 shares the minimum amount of information required to perform any function.

Referring now to FIG. 2, a block diagram illustrating a healthcare management system 110 in further detail is shown, according to an exemplary embodiment. Healthcare management system 110 is shown to include a plurality of functional engines and interfaces to perform the functions provided through system 110. An engine may be software on a computer system implementing the engine, a standalone computer system to implement the functions associated with the engine, software driven through a web-based interface, etc. An interface generally includes a graphical user interface and/or web-based interface to allow a user to provide input and receive output in interaction with underlying engines and/or computing systems.

System 110 includes a user management engine 202, a care calendar engine 204, a care task list engine 206, a care recipient communication engine 208, a home care research repository 210, a professional management system engine 212, a hospital communication engine 214, and a validation engine 216. Although system is 110 is shown and described herein as including specific repositories and engines, it should be understood that system 110 may include additional interfaces and/or engines associated with any functionality described herein.

System 110 is configured such that the primary caregiver is the primary user and is provided full access to the functionality of system 110. According to an exemplary embodiment, however, system 110 allows use by secondary caregiver users and/or community users where their use is restricted to functions specifically associated with their identification value and designated by the primary caregiver user.

Referring now to FIG. 3 in combination with FIG. 2, a healthcare management system interface 300 is shown, according to an exemplary embodiment. Healthcare management system interface is configured to allow a user to utilize interfaces to access one or more engines associated with healthcare management system 110. Accordingly, interface 300 includes a user management interface 302, a healthcare calendar display interface 304, a care task list interface 306, a care recipient communication interface 308, a resource repository interface 310, a professional home care management interface 312, and a hospital information interface 314. Although interface 300 is shown as including particular implementations of interfaces and/or as having specific functions associated with those interfaces, one of ordinary skill in the art will recognize that interface 300 may be configured to implement any activity described herein.

Generally, healthcare management system interface 300 will be configured to display information and implement functions for a single care recipient. However, interface 300 may also be configured for a couple or a group of individuals. One example of a group of individuals appropriate for such a grouping includes a care recipient care group having a similar diagnosed condition and being cared for within a single home care residence.

Using the user management interface 302, a primary caregiver performs a task of establishing one or more groups of users or individual users, wherein each user is designated as either a secondary caregiver or a community member. Each user is assigned unique identification information allowing them to access and identify themselves to system 110. The primary caregiver further sets use and permission levels controlling access to functionality and information using system 110. Generally, users designated as secondary caregiver users will be provided with a higher degree of access and/or functionality compared to community users. User management interface 302 allows the primary caregiver to set permissions for an entire group of users. For example, a primary caregiver may configure system 110 to allow secondary caregiver users to have full access to functions and information associated with care task list engine 206. In contrast, the primary caregiver may configure system 110 to restrict community users to functionality and information associated with care recipient communication interface 208.

User management engine 202 allows users to request designation as a secondary caregiver user or community user without intervention by the primary caregiver user. According to an exemplary embodiment, engine 202 provides a listing of user requests to the primary caregiver to allow the primary caregiver to accept or reject the requests prior to creating user accounts.

Using the healthcare calendar display interface 304, system 110 provides an interface to care calendar engine 204 to allow a user to schedule, update, list and manage appointments related to home healthcare activities. Each appointment is implemented as a calendar item including a description of the caretaking event and a caregiver designation field. According to an exemplary embodiment, a primary caregiver uses calendar interface 304 to create appointments, including recurring appointments, invite people to attend the appointments, set alerts for appointments, etc. Calendar 204 further displays a plan of care, indicating patient activities for certain days, expected milestones for the patient to achieve, such as therapy goals, etc.

Calendar engine 204 also displays patient condition information. The patient condition information includes measured values, forecasted changes, patient goals, etc. Measured values are manually entered, imported from an electronic medical record, received from one or more automated devices, etc. Forecasted changes to the recipient condition may occur, for example, wherein a patient has a physical limitation, a cognitive disease, a terminal condition, etc. having a known progression, rate.

Using the care task list interface 306, system 110 provides an interface to care task list engine 206 to allow a user to create, populate and manage one or more task lists associated with homecare activities. The activities may be any caretaking event to be performed by a caregiver the benefit of a home health care recipient. Each task list entry is implemented as a task list item including a description of the caretaking event and a caregiver designation field. System 110 includes one or more pre-populated lists, related to common tasks of caring for a care recipient. Exemplary task lists include shopping task lists, doctor visit task lists, home safety check task lists, household task lists, financial planning task lists, end-of-life task lists, and family meeting task lists. According to an exemplary embodiment, the pre-populated lists are customized based on one or more attributes associated with the care recipient.

According to an exemplary embodiment, the information in system 110 is continuously modified and updated based on forecasted, detected and/or manually entered changes to the care recipient's condition. For example, a task list may be generated specifically describing tasks associated with caring for a care recipient having stage 1 cancer, but upon determining that the patient has gone into remission, the tasks list engine 206, the calendar engine 204, etc., are configured to update the changed condition.

Advantageously, performing and tracking the provision of home health care tasks can greatly reduce the likelihood of readmission to a hospital. A number of conditions, such as heart failure, COPD, joint replacement surgery, dementia, diabetes, and pneumonia are particularly suited to well defined tasks that can be performed to reduce the likelihood of readmission.

Further, system 110 is configured to provide different information in repository 210, calendar 204, task list 206, etc. based on the condition information. For example, where a condition indicates that a patient has a heart failure condition, system 110 is configured to emphasize the importance of weight monitoring and diet. Accordingly, calendar 204 is modified to include multiple weight measuring calendar items. System 110 receives the weight information directly, such as by communicating with a scale featuring ANT+ wireless communication capabilities. Task list items in task list 206 may include, but are not limited to, shopping lists including low sodium items, blood pressure monitoring, etc. Repository 210 may include articles directed to home safety, low sodium recipes, etc.

According to an exemplary embodiment, care task list engine 206 allows task list items to be linked to an appointment within calendar engine 204. For example, where a calendar item is associated with a plurality of tasks, such as obtaining a copy of medical records, driving the care recipient to a healthcare institution, fasting prior to an appointment, etc., task list engine 206 and calendar engine 204 generate task list items and calendar display items based upon required timing of those activities.

According to another exemplary embodiment, care task list engine 206 allows task list items to be assigned to one or more users of system 110 by providing information regarding the user in a caregiver designation field of the item. For example, system 110 allows a primary caregiver to delegate tasks to one or more secondary caregiver users. Additionally, engine 206 allows secondary caregiver users to volunteer to perform one or more tasks to ease the burden on the primary caregiver. Task list engine 206 is configured such that the primary caregiver can accept or reject task list delegations based on secondary caregiver volunteer requests.

Using the care recipient communication interface 308, system 110 facilitates communication between caregiver users and/or community users using system 110. Exemplary communications includes status updates including short statements written by caregiver users, community users, and/or the care recipient. Status updates include, but are not limited to, filtering status updates based on audience, allowing users to comment/respond to status updates, allowing users to post photos accompanied by comments, and providing an interface to a social networking website.

Communication display 308 further implements journal functionality allowing users to publish long-form updates or stories about care recipients, their memories or other topics. Similar to status updates, journal entries are linked to external social networking sites, commented on by other users, include photos, etc.

Communication display 308 allows interface 208 to implement a messaging function allowing users to send private messages to one or more groups of recipients, such as an individual user, all secondary caregiver users, all community users, all users, customized groups, etc.

Using the homecare resource repository interface 310, a user accesses home care resource repository 210 to access an information database specifically relevant to the condition associated with the care recipient that is the focus of system 100. Exemplary resources include e-books, articles, checklists, links to web-based forums, and links to websites related to the condition. According to exemplary embodiment, system 110 allows users to import information, task lists, calendar items, etc. directly from resources provided by interface 310 to one or more engines and/or interfaces of system 110.

Using a professional home care management interface 312, system 110 allows the user to access and utilize the services of a professional home care service provider through engine 212. Advantageously, using a professional home care service provider through system 110 allows a user to easily assign tasks, calendar items, etc. to the provider and allows the users to import information directly from the provider into system 110. For example, where a user contracts a provider to take a care recipient to a specific appointment, system 110 may create a calendar item associated with the appointment using the calendar engine 204. The appointment is color coded or otherwise designated as being performed by the provider as opposed to the care community. System 110 includes an interface for the provider to upload information such as a task list to prepare for the appointment, future calendar items and/or task list items based on expert knowledge of typical healthcare events associated with the appointment and/or the care recipient's condition. System 110 further receives information and/or links for storage within repository 210.

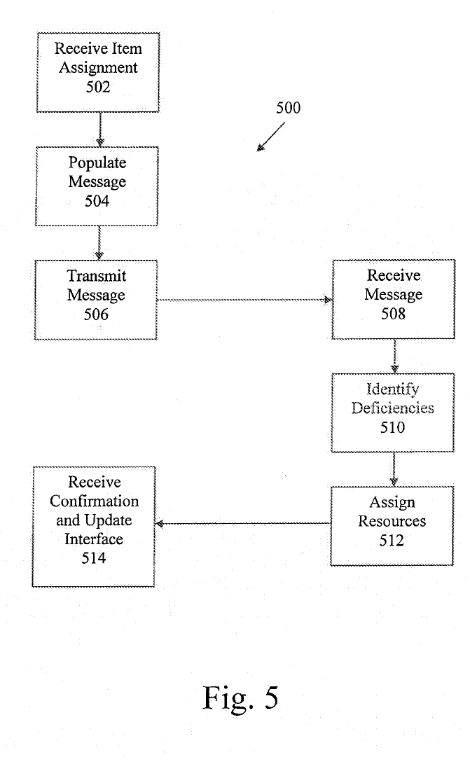

Referring now to FIG. 5, a flowchart 500 illustrating a method for assignment of an item displayed on the interface 300 to a professional home care management service is shown, according to an exemplary embodiment. In providing home health care, a primary or secondary caregiver may be faced with a situation in which they are unable to complete an item that are tasked with completing, such as a calendared appointment, a task list item, etc. Further, it may be that the user is not comfortable with delegating the task based on the complexity of the task, the timing of the task, the availability of caretakers, etc. Accordingly, professional home care management interface 312 is configured to display an “assign to professional service” indicia (not shown in FIG. 3) in association with selection of one or more of the items displayed on interface 300. The indicia may be presented as a selectable icon in interface 312, as a selectable icon in a calendar or task item, and/or as a pop up window where a user attempts to reschedule an item. This assignment button provides a “panic button” outlet for the caregiver that allows the user to offload tasks.

In a step 502, interface 300 receives a selection of the “assign to professional service” indicia. Upon receipt, interface 300 performs one or more additional steps as described hereinbelow to ensure professional delegation of the item. The steps are performed interactively, in which the user is prompted to provide additional into nation as needed, and/or automatically, in which system 110 is configured to automatically ensure delegation of the item based on stored information within system 110 and/or system 100. For purposes of explanation, the example of an upcoming doctor's appointment will be described where the caregiver having responsibility can no longer help with the appointment. Upon discovering the conflict, the caregiver can select the calendar item in interface 310 and then select the indicia in interface 312, for example.

In a step 504, system 110 is configured to generate a delegation message to be sent to the system 150 regarding the selected item. The message may be an instant message, an email message, etc. The contents of the message will vary based on the nature of the selected item. For example, wherein a calendar item is selected for delegation, the contents of the message may vary depending on whether the calendar item is relating to a doctor's appointment, an in home therapy appointment, a home health monitoring event, etc. Using the example of the doctor's appointment, system 110 generates a message including the timing of the calendar item and the calendar item. System 110 augments the message based on the association of system 110 with the system 100. For example, system 110 includes information downloaded from hospital 160, such as the patient's medical records, confirmation of the appointment time contact information for the doctor, etc. Other potential information may include billing information, insurance information, transportation requirements, regulatory reporting requirements associated with the appointment, and documentation requirements. The message includes requestor contact information (i.e. identification of the caregiver that selected the indicia and initiated the request).

In a step 506, system 110 transmits the message to the professional management system 150. Where the message may include private health information, such as medical records and/or billing information, system 110 is configured to encrypt the transmitted message.

In a step 508, system 150 receives the message and associated information, decrypting the information if needed. System 150 is associated with one or more systems 110 such that the above described message information is stored on system 150, reducing the necessity for transmitting sensitive information.

In a step 510, system 150 processes the received message to identify the type of item and the requirements for processing the item within system 150. For example, system 150 recognizes that, where the request is a doctor's appointment calendar item, the message should include insurance information, medical record information, doctor identification information, etc. If possible, system 150 is configured to interact with system 110 to cure any deficiencies, such as by electronically requesting transmission of doctor contact information, without requiring caregiver interaction.

In a step 512, system 150 is configured to assign one or more resource to the item received in the message. The nature of the resources assigned can vary greatly dependent on the nature of the item, the patient themselves, etc. For example, continuing the doctor's appointment example, the assigned resource is a driver to transport the patient from their home to the doctor's appointment and back. However, if system 110 and/or system 150 have additional information indicating the patient is high risk, assigning resources includes assigning a trained caretaker and providing medical resources in case they are needed.

Assigning a resource includes scheduling a video conferencing session between system 110 and system 150. For example, where a caretaking event is the performance of home health are monitoring using one or more medical devices connected to system 110, system 150 establishes a video conference between system 110 and system 150 at the time of the event. The information transmitted in step 512 includes information required to establish the video conference session, a test of, the system 110 to configure the video conference link, confirm capabilities, etc. In the video conference session, an employee associated with system 150, whose identification was transmitted in step 512, provides instructions to the user regarding how to connect the medical device, review output from the medical device and provides instructions and receive visual confirmation regarding usage.

In a step 514, system 150 is configured to generate an item delegation message including information regarding the assigned resources. For example, where the assigned resource is a driver, the information may include the driver's name, a photo, contact information, expected arrival time for the transportation, etc.

In a step 516, system 110 receives the item delegation message and associates the received information with the item within interface 300. For example, following delegation, selection of the doctor's appointment in calendar 304 will display the calendar item along with an indication that the item has been delegated, identification of a driver, etc. The calendar 304 is modified to include, for example, the expected arrival time of the driver at the patient's home, etc. based on the information received from system 150.

Referring again to FIG. 3, using a hospital interface 314, a user uses hospital engine 214 to receive and/or send information associated with the care recipient to and from a hospital providing medical care services to the care recipient. Hospital engine 214 implements functions to allow a user to, for example, schedule appointments, download task lists generated by healthcare professionals, and download and/or upload information to their electronic medical record.

According to an exemplary embodiment, system 110 further includes a validation engine 216. Validation engine 216 implements a method to restrict one or more activities associated with system 110 until the activity to be performed and/or a user performing the task has been validated. For example, task list items are restricted such that the task list item may only be performed by a user recognized as being a healthcare professional such as a registered nurse. Accordingly, system 110 is configured such that the restricted task list item may only be delegated, performed, and/or otherwise indicated as being completed by a user recognized as a healthcare professional. Validation engine 216 also performs one or more credential checking functions, such as validating a user with a healthcare institution or an accreditation agency.

Care calendar engine 204 further includes a care calendar upload interface allowing one or more systems, such as hospital system 160, professional care management system 150, and regulatory agency system 140 to populate the care calendar appointments. Exemplary uploaded information includes, but is not limited to, a plan of care, patient goals, patient progression information, and patient results information.

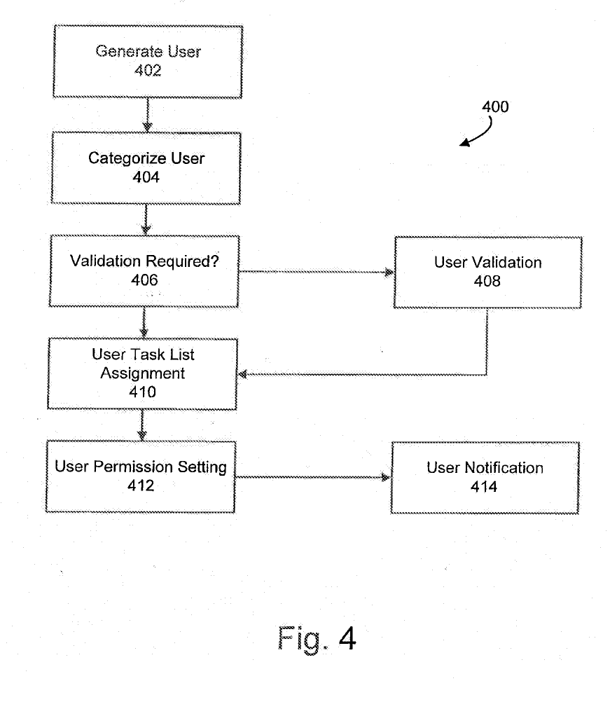

Referring now to FIG. 4, a flowchart 400 illustrating a method for generating a user account for system 110 is shown, according to an exemplary embodiment. The steps of flowchart 400 may be performed for a particular user and/or for groups of users within a similar category to facilitate user account creation.

In a step 402, a request to generate a user account is received by system 110. The request may be generated by the primary caregiver user, received from the user based on an invitation generated by the primary caregiver, or received from the user based on a request from a public information area of system 110. The user request includes user identification information, such as a name, address, email address, and a pass code provided by the primary caregiver or system 110. The received information is used to create a caregiver record including a number of fields for the information described above. A plurality of caregiver records are stored in a caregiver database maintained by system 110.

According to an exemplary embodiment, the user account request is a request for a specialized user account. Exemplary specialized user accounts include a physician user account, a regulatory agent user account, a medical billing user account, a pharmacy user account. System 110 receives and/or requests additional information where the request to generate a user account is a request for a specialized account as described in further detail below.

In a step 404, system 110 requests a user group designation, such as secondary caregiver, community, etc. System 110 may automatically assign the user to a group designation based on the information received in step 402. For example, where the received user account request includes an indication that the user is a family member, the user may be designated as a secondary caregiver based on the familial relationship.

In a step 406, system 110 determines whether the user account generation requires validation. Validation may be required where a user is to be designated as having a particular expertise, such as a nursing certification. User account validation is performed by system 110 using a variety of levels of validation. For example, where a care recipient may be particularly sensitive to information disclosure, system 110 may be configured such that validation is required for the generation of any user account. Validation may be mandated by system 110 based on the type of user account to be created. For example, where a user account is designated as, being associated with a healthcare professional, system 110 is configured to require external verification of the healthcare professional's credentials.

In a step 408, a user validation system is implemented using system 110. The validation is performed using system 110 and/or one or more external systems using network 180. Validation includes answering questions provided by the primary caregiver, providing validation from a secondary information source, such as an accreditation agency, etc.

In a step 410, system 110 and/or primary caregiver delegates one or more tasks to the user account. Tasks are delegated specifically by the primary caregiver, and may be delegated based on the type of user, based on the status of the account as a specialized user account, etc. System 110 further sets user permissions in a step 412 similar to step 410.

In a step 414, system 110 sends the user an indication of the successful creation of a user account. The account creation notification includes the user's identification information, a list of delegated tasks, a password where needed, and a link to a customized interface 300.

Although a particular series of steps are shown and described in a particular order in the flowcharts shown in FIG. 4 and described above, it should be understood that the methods described with reference to these flowchart may be implemented using more, fewer, and/or a different ordering of the steps to perform the functions described therein.

In operation, system 110 is provided to any person seeking assistance with caring for a home health care recipient. In a first step, the user receiving system 110 identifies the home health care recipient and their condition. Advantageously, system 110 can be self configuring, as described in further detail above, based on the identified condition.

After identifying the home health care recipient and their condition, the user preferably enters data for each of the caregivers that will be assisting in taking care of the home health care recipient. The data preferably includes identification information, relationship information, expertise information, and capability information for each caregiver. Once the data is entered, system 110 may be configured to transmit an invitation to the caregiver.

Each caregiver, accepting the invitation preferably receives access to a version of system 110 that is specifically customized to that caregiver. In one embodiment, system 110 is pre-configured to include the identification of the home health care recipient and their condition and caretaking events already entered by the primary user and/or automatically suggested by system 110. Further, the version of system 110 includes limited functionality based upon the caregiver information entered by the primary caregiver. Accepting an invitation results in a listing of the caregiver within system 110 as a person eligible to perform caretaking events.

System 110 is configured such that the primary user and/or any other caregiver may submit caretaking events to system 110. Exemplary caretaking events may be medical events, such as taking medicine, home health monitoring, and attending appointments with physicians and/or personal events such as attending church, going to the grocery store, visiting friends, and shoveling a sidewalk. Creation of a new caretaking event within system 110 includes assignment of at least one caregiver to each newly created caretaking event. Assigning an event to a caregiver triggers system 110 to send a message to the caregiver giving them the option to accept the event, assign a professional service to perform the caretaking, etc.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

It is claimed:

1. A computer-implemented home care management system for managing the home care of a patient, comprising:
(a) a care calendar engine configured to receive and track one or more calendar items, each calendar item including a caretaking event and a caregiver designation field;
(b) a care task list engine configured to receive and track one or more task list items, each task list item including a caretaking event and a caregiver designation field;
(c) a caregiver database, including one or more caregiver records, each caregiver record including identification of a caregiver, a caregiver categorization, and a listing of caregiver competencies;
(d) a care management interface configured to display the calendar items and care task list items and facilitate assignment of at least one caregiver record with each of the calendar items and care task list items in the caregiver designation field, wherein a caretaking event is an item to be performed by the caregiver identified in the caregiver record taken for the benefit of a home health care recipient; and
(e) a professional home care management interface configured to allow a caregiver assigned to a caretaking event to assign performance of a caretaking event to a professional, including
transmitting a home care management request including the caretaking event to a professional home care management system,
displaying a confirmation received from the professional home care management system that the task has been assigned to the professional home care management system in the care management interface.

2. The system of claim 1, wherein the confirmation is configured to include additional information related to the performance of the caretaking event and the care management interface is configured to display the additional information in combination with the item including the caretaking event.

3. The system of claim 2, wherein the additional information includes an identification of the caregiver assigned to perform the caretaking event.

4. The system of claim 3, wherein the identification of the caregiver includes a photograph of the caregiver assigned to perform the caretaking event and the care management interface is configured to display the photograph in combination with the item including the caretaking event.

5. The system of claim 2, wherein the additional information includes, professional management timing information that is different from timing information associated with the caretaking event and the care management interface is configured to generate or modify a calendar item based on the professional management timing information.

6. A computer-implemented home care management system for managing the home care of a patient, comprising:
(a) a care calendar engine configured to receive and track one or more calendar items, each calendar item including a caretaking event and a caregiver designation field;
(b) a care task list engine configured to receive and track one or more task list items, each task list item including a caretaking event and a caregiver designation field;
(c) a caregiver database, including one or more caregiver records, each caregiver record including identification of a caregiver, a caregiver categorization, and a listing of caregiver competencies; and
(d) a care management interface configured to display the calendar items and care task list items and facilitate assignment of at least one caregiver record with each of the calendar items and care task list items in the caregiver designation field,
wherein a caretaking event is an item to be performed by the caregiver identified in the caregiver record taken for the benefit of a home health care recipient.

7. The system of claim 6, wherein the caretaking events are downloaded over a network connection from a hospital and include patient medical information generated by a healthcare provider at the hospital.

8. The system of claim 7, wherein the care management interface is configured to modify one or more existing caretaking events based on the received patient medical information.

9. The system of claim 6, wherein at least one caretaking event is associated with an expertise requirement specific to a home health care recipient medical condition.

10. The system of claim 9, wherein the caregiver records are configured to include a caregiver expertise field and the care management interface is configured such that caretaking events having an expertise requirement can only be assigned to caregiver having a correlated expertise in their caregiver record.

11. The system of claim 10, wherein the care management system is configured to require validation information, received from an external system, prior to populating the caregiver expertise field.

12. The system of claim 6, wherein the care management system is further configured to
receive confirmation of completion of the caretaking events over a network connection, and
generate and transmit a home healthcare status report over the network connection.

13. The system of claim 6, wherein the caretaking events are customized based on a received patient condition for the home health care recipient.

14. A computer-implemented method for providing a home care management system, comprising:
(a) receiving and tracking one or more calendar items, each calendar item including a caretaking event and a caregiver designation field;
(b) receiving and tracking one or more task list items, each task list item including a caretaking event and a caregiver designation field;
(c) receiving an assignment of at least one caregiver record, each caregiver record including identification of a caregiver, a caregiver categorization, and a listing of caregiver competencies, with the calendar items and care task list items in the caregiver designation field, wherein a caretaking event is an item to be performed by the caregiver identified in the caregiver record taken for the benefit of a home health care recipient; and
(d) delegating at least one caretaking event to a professional home care management interface to allow a caregiver assigned to a caretaking event to assign performance of a caretaking event to a professional, including
transmitting a home care management request including the caretaking event to a professional home care management system,
displaying a confirmation received from the professional home care management system that the task has been assigned to the home care management system.

15. The method of claim 14, wherein the confirmation is configured to include additional information related to the performance of the caretaking event and the care management interface is configured to display the additional information in combination with the item including the caretaking event.

16. The method of claim 15, wherein the additional information includes an identification of the caregiver assigned to perform the caretaking event.

17. The method of claim 16, wherein the identification of the caregiver includes a photograph of the caregiver assigned to perform the caretaking event and the care management interface is configured to display the photograph in combination with the item including the caretaking event.

18. The method of claim 14, wherein the additional information includes professional management timing information that is different from timing information associated with the caretaking event and the care management interface is configured to generate or modify a calendar item based on the professional management timing information.

19. The method of claim 14, wherein at least one caretaking event is associated with an expertise requirement.

20. The method of claim 19, wherein the caregiver records are configured to include a caregiver expertise field and further including rejecting assignments of caretaking events having an expertise requirement to caregiver records that do not have a correlated expertise in their caregiver record.

21. The method of claim 20, further including receiving a request to associate an expertise with a caregiver record and requiring validation information, received from an external system, prior to populating the caregiver expertise field.

22. A computer-implemented home care management system configured to facilitate tracking and completion of events related to taking care of an individual in a home environment with the assistance of a professional home care management system, comprising:
(a) a home care management interface configured to track a plurality of caretaking events, including
a caretaking event display,
a caregiver database, including one or more caregiver records, each caregiver record including identification of a caregiver, and
a care assignment interface configured to receive
assignment of at least one caregiver record with the caretaking events and
assignment of at least one caretaking event to a third party including displaying the assignment and one or more resources assigned to the caretaking event by the third party in the home care management interface.
